(19) United States
(12) Patent Application Publication
(10) Pub. No.: US 2020/0375147 A1
(43) Pub. Date: Dec. 3, 2020

(54) UTILITY HYDRATION PET VEST

(71) Applicant: KAYNINE, LLC, PASADENA, CA (US)

(72) Inventor: GEGHARD OHANIAN, Pasadena, CA (US)

(21) Appl. No.: 16/428,869

(22) Filed: May 31, 2019

(51) Int. Cl. A01K 7/00; A01K 13/00; A01K 27/00

(52) U.S. Cl. CPC A01K 7/00; A01K 13/006; A01K 27/002; A01K 13/007; A01K 27/008

(57) ABSTRACT

A utility hydration pet vest is worn by a pet, like a dog, for protection and carrying water and liquid retention items. The vest is fabricated from Cordura® fabric. The pet vest comprises a body portion defined by an inner surface that engages the pet when adorned, and an outer surface. The body portion has a shoulder section that forms a pair of openings for the fore legs of the pet to pass through and move freely. The body portion is further defined by a rear section with an overlaying outside pocket layer. The outside pocket layers is formed together along a dividing line to define an isolated liquid compartment comprising a liquid bladder for carrying liquid, and a utility compartment having access openings for holding a collapsible liquid bowl and liquid tube to conveniently water the pet. The vest may also include cooling and heating elements, and dog boots.

### FIELD OF THE INVENTION

The present invention relates generally to a utility hydration pet vest. More so, the present invention relates to a vest that is worn by a pet, such as a dog, for protection, marking, and carrying objects; whereby the vest is fabricated from Cordura® fabric; whereby a liquid bladder fabricated of polyurethane is integrated in the vest; whereby the liquid bladder comprises a collapsible liquid bowl and liquid tube that fit into the vest so that the pet can be fed liquid from the bowl; whereby the vest may include accessories such as an electronic cooling and heating element and custom fit boots.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, when walking a pet, such as a dog, it can be advantageous to don a harness and/or vest on the pet. Often, a pet utility vest is used to carry and dispense plastic waste bags for collection of pet waste, and for carrying the pet waste until it can be disposed of properly. Such a utility vest may also be used for enhancing visibility of the pet during the day and night, and for covering the pet in cold and inclement weather conditions.

It is also recognized in the art that when exercising or walking the pet, the pet will need to be hydrated. Often, this has meant that whoever was walking the animal was also carrying their own water, and water for the animal. Thus, a water-carrying vest for the pet, which contains pockets for the pet to carry its own water bottles is known in the art. Such a design often requires removing a water container from the vest in order to hydrate the animal.

Other proposals have involved pet harnesses and vests. The problem with these vests is that they do not fit comfortably on the pt. Also, they do not have a convenient means to dispense and retain the liquid for watering the pet. Even though the above cited pet vests meet some of the needs of the market, a utility hydration pet vest that is worn by a pet, such as a dog, for protection, marking, and carrying objects; whereby the vest is fabricated from Cordura® fabric; whereby a liquid bladder fabricated of polyurethane is integrated in the vest; whereby the liquid bladder comprises a collapsible liquid bowl and liquid tube that fit into the vest so that the pet can be fed liquid from the bowl; whereby the vest may include accessories such as an electronic cooling and heating element and custom fit boots is still desired.

### SUMMARY

Illustrative embodiments of the disclosure are generally directed to a utility hydration pet vest. The pet vest is worn by a pet, such as a dog, for protection, marking, and carrying water and water holding items. The vest is fabricated from Cordura® fabric. A liquid bladder fabricated of polyurethane is integrated in the vest; whereby the liquid bladder comprises a collapsible liquid bowl and liquid tube that fit into the vest to conveniently water the pet.

The pet vest comprises a body portion defined by an inner surface that engages the pet when adorned, and an outer surface that faces away from the pet. The body portion is further defined by a shoulder section that forms a pair of openings for the fore legs of the pet to pass through and move freely.

The body portion is further defined by a rear section with an overlaying outside pocket layer. The outside pocket layers is formed together along a dividing line to define an isolated liquid compartment comprising a liquid bladder to carry a liquid, and an isolated utility compartment having access openings for holding a collapsible liquid bowl and liquid tube to conveniently water the pet. The vest may include accessories such as an electronic cooling and heating element and custom fit boots.

In one aspect, the utility hydration pet vest, comprises:
a body portion defined by an inner surface and an outer surface,
the body portion further defined by a shoulder section forming a pair of openings, and a rear section having an overlaying outside pocket layer on the outer surface of the body portion,
the outside pocket layer being formed along a dividing line to define an isolated liquid compartment having respective first and second access openings for receiving and storing liquid,
the outside pocket layer further being formed along the dividing line to define an isolated utility compartment having respective a third access opening for receiving and storing a dispensing tube defined by a pump end and a free end in fluid communication with the isolated liquid compartment, a pump operable at the pump end, and a collapsible drinking bowl;
a pair of front fastening straps disposed at the shoulder section of the body portion, the front fastening straps comprising a front detachably attachable end; and
a pair of rear fastening straps disposed at the rear section of the body portion, the rear fastening straps comprising a rear detachably attachable end.

In another aspect, the body portion is fabricated from a nylon, polyester blend.

In another aspect, the body portion is fabricated from a Cordura® fabric.

In another aspect, the body portion is resilient.

In another aspect, the body portion comprises a neoprene padding.

In another aspect, the body portion wraps around a dog.

In another aspect, the front legs of the dog pass through the pair of openings.

In another aspect, the divided line is stitched.

In another aspect, the isolated liquid compartment comprises a bladder.

In another aspect, the bladder comprises a polyurethane rubber sheet.

In another aspect, the liquid comprises water.

In another aspect, the front fastening straps comprise a 2 inch polyester webbing material.

In another aspect, the rear fastening straps comprise the polyester webbing material.

In another aspect, the fastening straps comprise a slider adjuster.

In another aspect, the front and rear detachably attachable ends comprise a snap-fit buckle.

In another aspect, the vest further comprises a heating element operable to heat the body portion.

In another aspect, the vest further comprises a cooling element operable to cool the body portion.

In another aspect, the vest further comprises multiple boots operable to fit the paws of the dog.

In another aspect, the boots comprise interchangeable soles.

One objective of the present invention is to provide a protective vest to a dog that carries a bladder of water for facilitated watering of the pet.

Another objective is to provide a collapsible bowl in the pocket of the vest for retaining water.

Yet another objective is to provide a vest that is quickly installed and operable to be fitted in a few quick motions with snap fit buckles, closures; whereby the design works around limbs and does not require the threading of limbs through the front openings.

Yet another objective is to provide a neoprene padding integrated into the vest to create greater comfort for the pet.

Yet another objective is to provide a durable, machine washable fabric.

Yet another objective is to provide heating and cooling elements in the body portion to regulate the temperature of the dog.

Yet another objective is to provide boots with interchangeable soles for different terrains for the dog to wear on the paws.

Yet another objective is to provide an inexpensive to manufacture pet utility vest.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary utility hydration pet vest donned by a dog, in accordance with an embodiment of the present invention;

FIG. 2 illustrates a left side top angle perspective view of the utility hydration pet vest, showing the body portion, pockets, and fastening means, in accordance with an embodiment of the present invention;

FIG. 3 illustrates a right side top angle perspective view of the utility hydration pet vest, showing the body portion, pockets, and fastening means, in accordance with an embodiment of the present invention;

FIG. 4 illustrates a perspective view of an exemplary utility hydration pet vest donned by a dog, with the pocket layer aligned with the belly of the dog, in accordance with an embodiment of the present invention;

FIG. 5 illustrates a perspective view of an exemplary shoulder section of the pet vest, in accordance with an embodiment of the present invention;

FIG. 6 illustrates a perspective view of an exemplary rear section of the pet vest, in accordance with an embodiment of the present invention;

FIG. 7 illustrates a perspective view of exemplary liquid retention items, including a collapsible bowl and a dispensing tube, in accordance with an embodiment of the present invention;

FIG. 8 illustrates a perspective view of the collapsible bowl receiving a liquid from the dispensing tube, in accordance with an embodiment of the present invention;

FIG. 9 illustrates a perspective view of exemplary heating element and a cooling element integrated into the pet vest, in accordance with an embodiment of the present invention; and

FIG. 10 illustrates a perspective view of exemplary boos with interchangeable soles being donned by a dog paw, in accordance with an embodiment of the present invention.

Like reference numerals refer to like parts throughout the various views of the drawings.

### DETAILED DESCRIPTION OF THE INVENTION

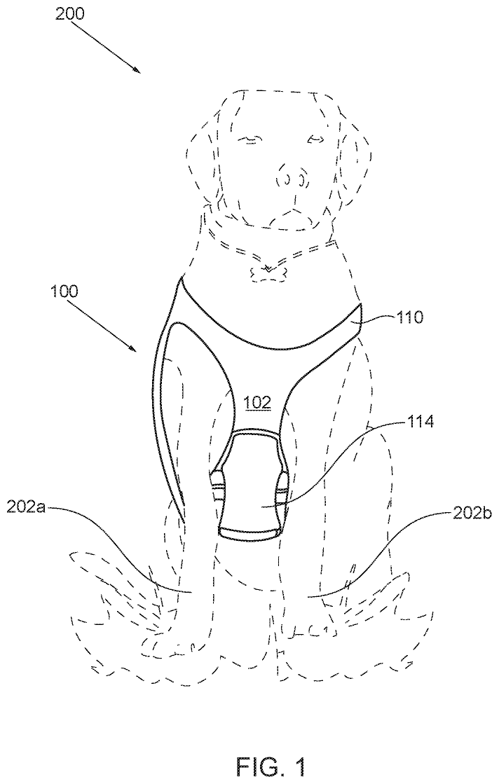

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

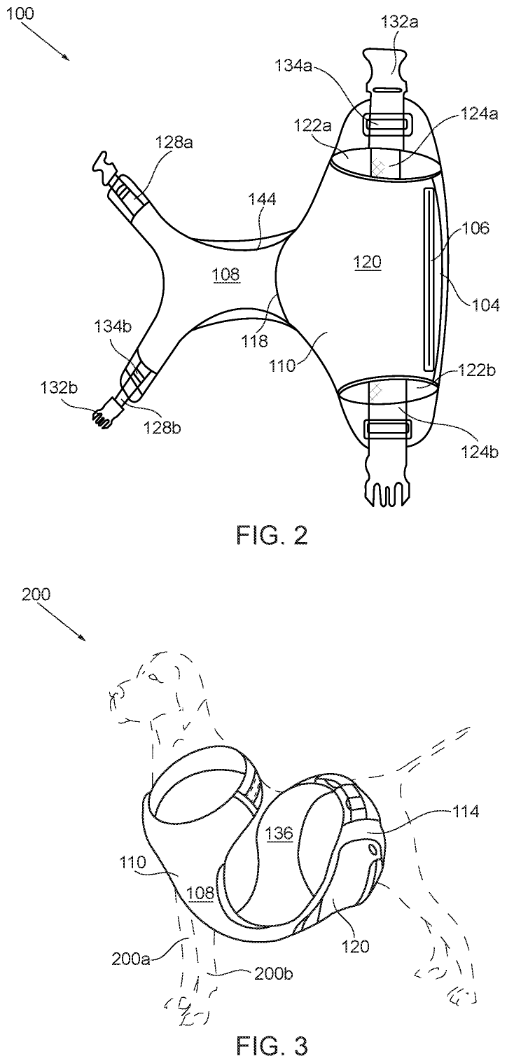

A utility hydration pet vest 100 is referenced in FIGS. 1-10. The pet vest 100 is a unique body covering for a pet 200, which may include a dog, cat, a livestock animal, and generally any animal that can be maintained. The pet vest 100 covers the back side, shoulder, and part of the front chest of the pet. The pet vest 100 has integrated therein, and overlaying pocket layer 116 divided into a liquid compartment 120 that stores a drinkable liquid; and a utility compartment 104 that stores liquid retention items, such as a collapsible bowl 706, and a dispensing tube 700 that carries the liquid from the liquid compartment 120 to the collapsible bowl 706. In this manner, the pet vest 100 carries its own hydration means.

In alternative embodiments the pet vest 100 can have a heating element 900 and/or a cooling element 902 that are operational in the fabric of the vest to generate heat and reduce heat in the body portion 102 of the vest 100, through various heating and cooling means known in the art. This helps adjust the temperature for the pet, and the temperature regulation of the pet creates a synergy with the hydration means. In yet other embodiments, the pet vest 100 provides customizable boots 1000a-b that can be worn by the pet for extra protection to the paws. The boots can have interchangeable soles 1002 to accommodate different terrains.

As FIG. 1 references, the pet vest 100 comprises a body portion 102 that substantially covers the front shoulder region and back of the pet 200. The body portion 102 materials are breathable and lightweight so that the vest 100 remain adorned on the pet all day under human supervision. The body portion 102 is defined by an inner surface 136 that engages the skin or for of the pet 200. Opposite the inner surface 136 is an outer surface 108 that faces outwardly and away from the pet.

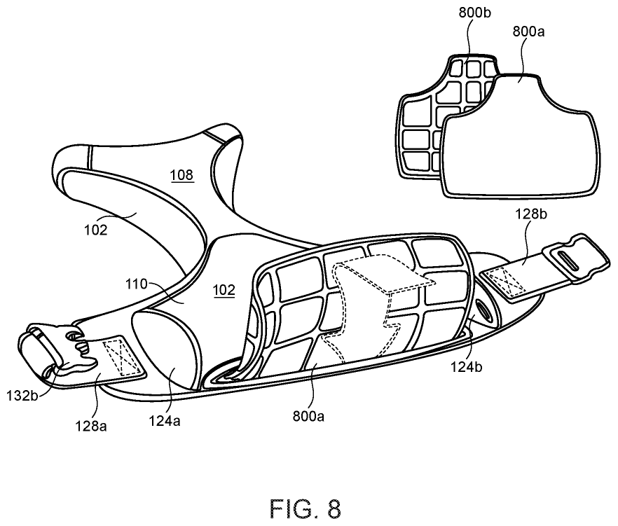

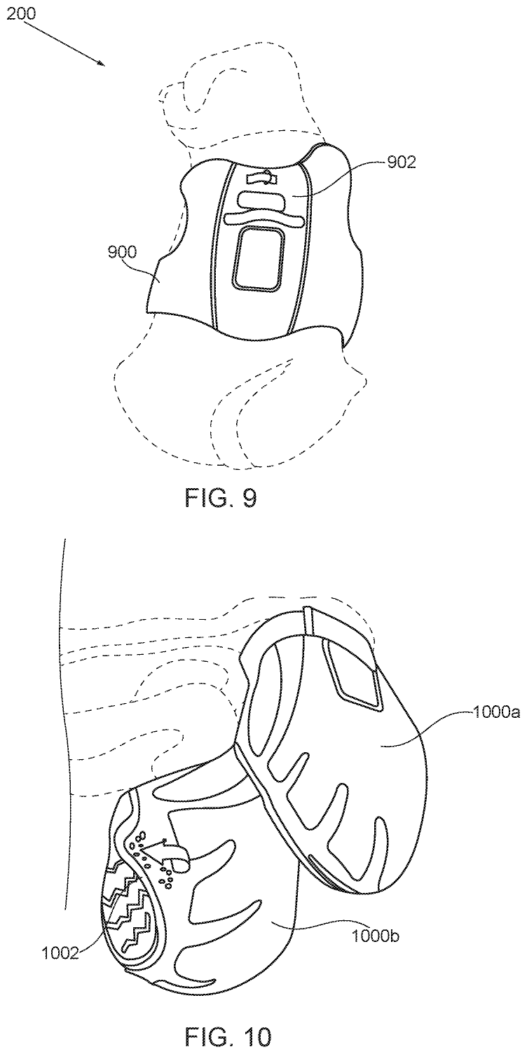

Looking ahead to FIG. 8, the body portion 102 comprises at least one resilient, neoprene padding 800a, 800b. This creates greater comfort for the pet 200. In one non-limiting embodiment, the body portion 102 comprises a Cordura® fabric. The Cordura® fabric creates durability for the use and abuse fabrics go through daily. This can include abrasion, scuffs, and tears from the pet 200 rubbing against surfaces, biting, and soiling the fabric. Additionally, the color fastness of the fabric allow for multiple, decorative colors used for ornamental purposes, and functional identification.

The body portion 102 is also defined by a shoulder section 110 that overlays the shoulders, and part of the front limbs 202a-b and chest area of the pet 200. Looking ahead to FIG. 5, the shoulder section 110 forms a pair of openings 112a, 112b that are sized and dimensioned to enable passage of the front limbs 202a, 202b of the pet 200. The openings may be oversized to enable freer movement; or may form a snug fit with the front limbs 202a, 202b. The body portion 102 is further defined by a rear section 114 that overlays back, and part of the hind legs of the pet 200.

In order to secure the body portion 102 around the torso of the pet, as shown in FIG. 1, the pet vest 100 provides a pair of front fastening straps 124a, 124b that extend from opposite sides of the shoulder section 110 of the body portion 102. The front fastening straps 124a-b may include 2″ nylon webbing, and a pair of front detachably attachable ends 126a, 126b. The front detachably attachable ends 126a-b may include a snap-fit buckle 132a that attaches and detaches in in a quick, efficient manner. The front fastening straps 124a-b are also size adjustable through use of a slide adjuster 134a, or other size adjusting buckles known in the art. This allows the width of the shoulder portion 110 to be adjusted to accommodate variously sized and shaped pets. Also, the comfort of the pet 200 can be accommodated more easily through the size adjustability means.

As a complement to the front fastening straps 124a-b, a pair of rear fastening straps 128a, 128b are disposed at the rear section 114 of the body portion 102. The rear fastening straps 128a-b may include 2″ nylon webbing. The rear fastening straps 128a-b extend from opposite sides of rear section 114, and terminates at a pair of rear detachably attachable ends 130a, 130b. The rear detachably attachable ends 130a-b may include a snap-fit buckle 132b that attaches and detaches in in a quick, efficient manner. And as shown in FIG. 3, the rear fastening straps 128a-b are size adjustable through use of a slide adjuster 134b, or other size adjusting buckles 132b known in the art. This allows the width of the rear section 114 to be adjusted to accommodate variously sized and shaped pets 200.

In donning the body portion 102 onto the pet 200, the inner surface 136 is aligned with the back of the pet 200 and draped over rib cage section. The front limbs 202a-b are passed through corresponding front openings 112a-b. The body portion 102 is then aligned across the longitudinal of the back of the pet 200. The front fastening straps 124a-b are pulled down across the chest of the pet 200 and attached front detachably attachable ends 126a-b, i.e, snap-fit buckles 132a-b. Though other fastening means known in the art may also be used.

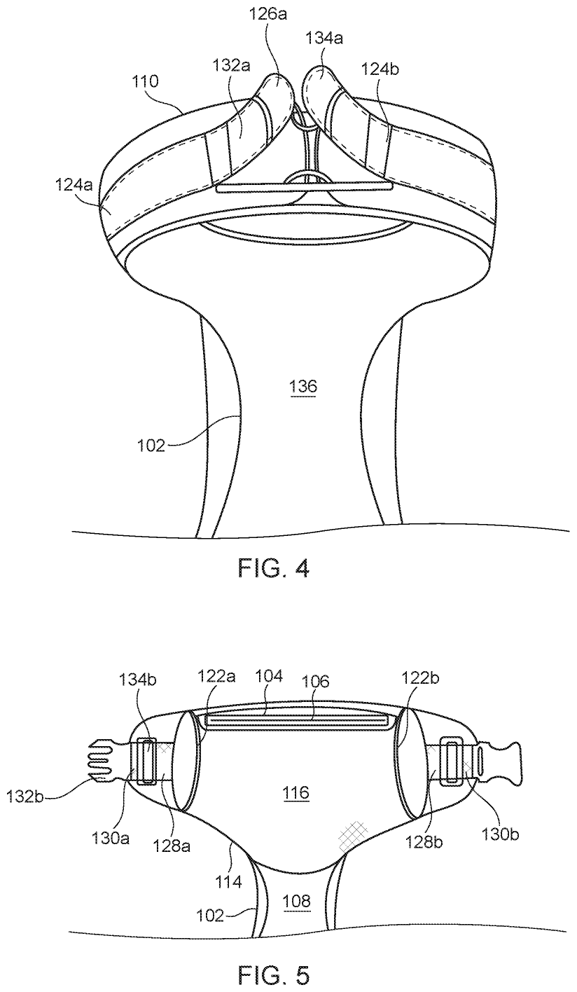

Next, the rear fastening straps 128a-b are pulled down across the belly of the pet and attached accordingly. At this point, the shoulder section 110 draped over the front region of the pet, while the rear section 114 drapes over the rear section 114. The body portion 102 is also snug, yet comfortably loose, across the back of the pet 200. As discussed below, an overlaying pocket layer 116 orients upwardly across the back of the pet 200, so as to provide access to a liquid and liquid retaining the items. However in alternative embodiments shown in FIG. 4, the body portion 102 is rotated along the torso of the pet 200, so that the pocket layer 116 lies along the belly, rather than the back. In either case, the shoulder section 110 is more forward than the rear section 114 of the body portion 102.

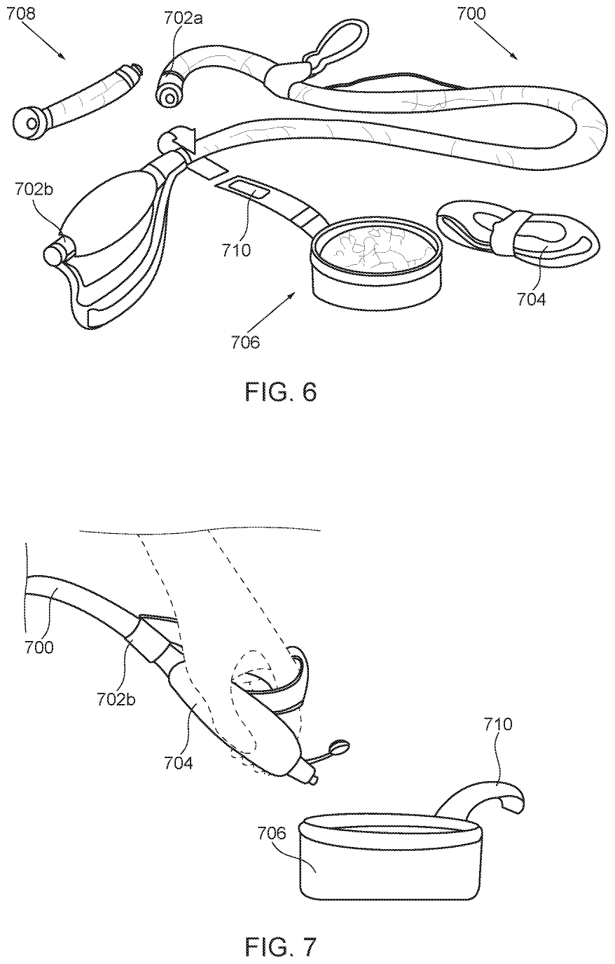

As shown in FIG. 6, the rear section 114 of the body portion 102 comprises an overlaying outside pocket layer 116 that forms on the outer surface 108 of the body portion 102. The outside pocket layer 116 is defined along a dividing line 118, which may be stitched, glued, welded, or detachably fastened in some embodiments. The dividing line 118 defines an isolated liquid compartment 120 having respective first access opening 122a and a second access opening 122b that is sized to enable passage of a liquid in and out of the liquid compartment 120. The first and second access openings 122a-b may have a zipper, a button, or a hook and loop fastener to enable passage thereto. The liquid may include water, or other liquid suitable for the pet to drink.

In one non-limiting embodiment, the isolated liquid compartment 120 is a rubber bladder made up of a polyurethane rubber sheet. The isolated liquid compartment 120 is generally resilient, so that the liquid can be squeezed out of either the first or second access openings 122a, 122b, if necessary. The isolated liquid compartment 120 provides a unique mechanism to dispense the liquid to the pet.

Looking now at FIG. 7, the pet vest 100 also provides multiple liquid retention items to help carry the liquid out of the isolated liquid compartment, and then retain the liquid for the pet to drink from. To carry and store these liquid retention items, the outside pocket layer 116 also forms along the dividing line 118 to define an isolated utility compartment 104 having respective a third access opening 106. In some embodiments, the third access opening 106 may have a zipper, a button, or a hook and loop fastener, so as to enable passage thereto.

The isolated utility compartment 104 may be smaller than the liquid compartment, and serves to receive and store a dispensing tube 700 that carries the liquid from the liquid compartment. The dispensing tube 700 is defined by a pump end 702b and a free end 702a that is in fluid communication with the isolated liquid compartment. In some embodiments, a pump 704 is operable at the pump end 702b. The pump 704 allows the user to squeeze and create a vacuum in the dispensing tube 700 to that draws liquid from the liquid compartment to discharge through the pump end 702b. In one non-limiting embodiment, the pump 704 is a simple inflated bulb that is manually squeezed to draw liquid from the liquid compartment. In another embodiment, the pump is integral with the pump end 702b of the dispensing tube 700.

Additionally, inside the utility compartment a collapsible drinking bowl 706 is contained, and easily remove for retaining the liquid. In some embodiments, the collapsible drinking bowl 706 may include a polyurethane or other material that is resilient to collapse, yet sufficient the rigid to retain the liquid. In yet other embodiments, an extension tube 708 may also be included in the utility compartment to extend the length of the dispensing to. Also, a bowl fastener 710 detachably couples the collapsible bowl dispensing tube 700.

As FIG. 8 shows, the liquid can be dispensed directly from the liquid compartment 120 into the collapsible bowl 706 for the pet 200 to drink from. A dispensing tube 700, discussed below, carries the liquid from the liquid compartment 120 for dispensing through a pump end 702b. It is significant to note that all the liquid retention items in the utility compartment 104 are resilient and collapsible. In this manner the utility compartment 104 is generally smaller than the liquid compartment 120, which must hold a volume of liquid. However in other embodiments, the pet 200 may be allowed to drink directly from the pump end 702b of the dispensing tube 700.

Turning now to FIG. 9, the pet vest is unique in providing alternative versions that further improve the conditions of the pet. In one embodiment the pet vest includes a heating element 900 that is operable to heat the body portion. The heating element 900 may include chemical composition integral in the body portion, which can be heated through motion by the pet or by manipulation of the body portion. In other embodiments, the heating element may include an electric blanket having small wires that heat up after being powered by a battery.

Conversely, the pet vest 100 may also include a cooling element 902 operable to cool the body portion. Cooling element may simply include an additional pocket or space in the body portion that contains ice, dry ice, or a chemical that maintains a low temperature. In yet another alternative embodiment, the vest further includes multiple boots 1000a, 1000b that are operable to fit the paws of the dog. As FIG. 10 shows, the boots 1000a-b comprising multiple interchangeable soles 1002 that accommodate different terrains. For example, a rigid sole may be useful for climbing a mountain or hiking. While a soft sole may be suitable for indoor purposes.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A utility hydration pet vest, the vest comprising:
a body portion defined by an inner surface and an outer surface,
the body portion further defined by a shoulder section forming a pair of openings, and a rear section having an overlaying outside pocket layer on the outer surface of the body portion,
the outside pocket layer being formed along a dividing line to define an isolated liquid compartment having respective first and second access openings,
the outside pocket layer further being formed along the dividing line to define an isolated utility compartment having a third access opening, the utility compartment operable to receive and store a dispensing tube defined by a pump end and a free end in fluid communication with the isolated liquid compartment, the utility compartment further being operable to receive a collapsible drinking bowl;
a pair of front fastening straps disposed at the shoulder section of the body portion, the front fastening straps comprising a front detachably attachable end; and
a pair of rear fastening straps disposed at the rear section of the body portion, the rear fastening straps comprising a rear detachably attachable end.

2. The vest of claim 1, wherein the body portion is fabricated from a nylon, polyester blend.

3. The vest of claim 1, wherein the body portion is fabricated from a Cordura® fabric.

4. The vest of claim 1, wherein the body portion comprises at least one neoprene padding.

5. The vest of claim 1, further comprising a pump disposed at the pump end of the dispensing tube.

6. The vest of claim 5, wherein the front limbs of the dog pass through the pair of openings in the body portion.

7. The vest of claim 6, further comprising multiple boots operable to fit the paws of the dog.

8. The vest of claim 7, wherein the boots comprise multiple interchangeable soles.

9. The vest of claim 1, wherein the divided line is stitched.

10. The vest of claim 1, wherein the isolated liquid compartment comprises a bladder.

11. The vest of claim 10, wherein the bladder comprises a polyurethane rubber sheet.

12. The vest of claim 1, wherein a liquid in the isolated liquid compartment comprises water.

13. The vest of claim 1, wherein the front and rear fastening straps comprise a 2 inch polyester webbing material.

14. The vest of claim 13, wherein the fastening straps comprise a slider adjuster.

15. The vest of claim 14, wherein the front and rear detachably attachable ends comprise a snap-fit buckle.

16. The vest of claim 1, further comprising a heating element operable to heat the body portion.

17. The vest of claim 1, further comprising a cooling element operable to cool the body portion.

18. A utility hydration pet vest, the vest comprising:
a body portion defined by an inner surface and an outer surface,
the body portion further defined by a shoulder section forming a pair of openings and a rear section having an overlaying outside pocket layer on the outer surface of the body portion, the body portion comprising a neoprene padding,
the outside pocket layer being formed along a dividing line to define an isolated liquid compartment having respective first and second access openings for receiving and storing a liquid, the isolated liquid compartment comprising a bladder,
the outside pocket layer further being formed along the dividing line to define an isolated utility compartment having a third access opening, the utility compartment operable to receive and store a dispensing tube defined by a pump end and a free end in fluid communication with the isolated liquid compartment, the utility compartment further being operable to receive a collapsible drinking bowl;
a pump operable at the pump end of the dispensing tube;
a pair of front fastening straps disposed at the shoulder section of the body portion, the front fastening straps comprising a front detachably attachable end;
a pair of rear fastening straps disposed at the rear section of the body portion, the rear fastening straps comprising a rear detachably attachable end,
the front and rear detachably attachable ends comprising a snap-fit buckle and a slide adjuster.

19. The vest of claim 18, further comprising a heating element and a cooling element operable to heat the body portion, respectively.

20. A utility hydration pet vest, the vest consisting of:
a body portion defined by an inner surface and an outer surface, the body portion operable to be worn by a dog, the body portion comprising a Cordura® fabric,
the body portion further defined by a shoulder section forming a pair of openings for enabling passage of the limbs of the dog, the body portion further defined by a rear section having an overlaying outside pocket layer on the outer surface of the body portion,
the outside pocket layer being formed along a stitched dividing line to define an isolated liquid compartment having respective first and second access openings for receiving and storing a liquid,
the outside pocket layer further being formed along the dividing line to define an isolated utility compartment having a third access opening, the utility compartment operable to receive and store a dispensing tube defined by a pump end and a free end in fluid communication with the isolated liquid compartment, the utility compartment further being operable to receive and store a collapsible drinking bowl;
a pump operable at the pump end of the dispensing tube;
a pair of front fastening straps disposed at the shoulder section of the body portion, the front fastening straps comprising a front detachably attachable end, the front fastening straps comprising a nylon webbing;
a pair of rear fastening straps disposed at the rear section of the body portion, the rear fastening straps comprising a rear detachably attachable end, the rear fastening straps comprising a nylon webbing,
the front and rear detachably attachable ends comprising a snap-fit buckle and a slide adjuster;
a heating element operable to heat the body portion;
a cooling element operable to cool the body portion; and
multiple boots operable to fit the paws of the dog, the boots comprising multiple interchangeable soles.
